(19) United States
(12) Patent Application Publication
(10) Pub. No.: US 2011/0273481 A1
(43) Pub. Date: Nov. 10, 2011

(54) PLASMA DISPLAY DEVICE AND DRIVING METHOD OF PLASMA DISPLAY PANEL

(75) Inventors: Yoshiki Tsujita, Osaka (JP); Minoru Takeda, Osaka (JP); Seiji Furusawa, Osaka (JP); Kenji Sasaki, Osaka (JP)

(73) Assignee: Panasonic Corporation, Osaka (JP)

(21) Appl. No.: 12/922,779

(22) PCT Filed: Jan. 27, 2010
(86) PCT No.: PCT/JP2010/000452

§ 371 Date: Sep. 15, 2010

(30) Foreign Application Priority Data
Jan. 28, 2009 (JP) 2009-016184

(51) Int. Cl. G09G 3/28; G09G 5/10

(52) U.S. Cl. 345/690; 345/63

(57) ABSTRACT

The plasma display device has a sustain pulse generating circuit for generating sustain pulses in a sustain period. The sustain pulse generating circuit generates at least two kinds of sustain pulses of different rising gradients in the sustain period, generates a predetermined number of sustain pulse whose rising gradient becomes steeper to the latter half in at least one-side electrode in the sustain period after first two sustain pulses and except an erasing pulse, and continuously generates the sustain pulses while the rising gradient of the sustain pulses is varied in response to the light emitting rate of the plasma display panel in the sustain period.

This application is a U.S. National Phase Application of PCT International Application No. PCT/JP2010/000452.

### TECHNICAL FIELD

The present invention relates to a plasma display device used in a wall-mounted television or a large monitor, and a driving method of a plasma display panel.

### BACKGROUND ART

An alternating-current surface discharge type panel typical as a plasma display panel (hereinafter referred to as “panel”) has many discharge cells between a front plate and a rear plate that are faced to each other. The front plate has the following elements:

a plurality of display electrode pairs disposed in parallel on a front glass substrate; and

a dielectric layer and a protective layer for covering the display electrode pairs.

Here, each display electrode pair is formed of a pair of scan electrode and sustain electrode. The rear plate has the following elements:
a plurality of data electrodes disposed in parallel on a rear glass substrate;
a dielectric layer for covering the data electrodes;
a plurality of barrier ribs disposed on the dielectric layer in parallel with the data electrodes; and
phosphor layers disposed on the surface of the dielectric layer of the rear plate and on side surfaces of the barrier ribs.
   The front plate and rear plate are faced to each other so that the display electrode pairs three-dimensionally intersect with the data electrodes, and are sealed. Discharge gas containing xenon with a partial pressure of 5%, for example, is filled into a discharge space in the sealed product. Discharge cells are disposed in intersecting parts of the display electrode pairs and the data electrodes. In the panel having this structure, ultraviolet rays are emitted by gas discharge in each discharge cell. The panel excites respective phosphors of red (R), green (G), and blue (B) with the ultraviolet rays to emit light, and performs color display.

A subfield method is generally used as a method of driving the panel. In this method, one field period is divided into a plurality of subfields, and the subfields in which light is emitted are combined, thereby performing gradation display.

Each subfield has an initializing period, an address period, and a sustain period. In the initializing period, initializing discharge is caused, a wall charge required for address operation in the subsequent address period is formed on each electrode, and a priming particle (an excitation particle as an initiating agent for discharge) for stably causing address discharge of the address operation is generated. In the address period, address pulse voltage is selectively applied to a discharge cell where display is to be performed to cause address discharge, thereby forming a wall charge (hereinafter, this operation is referred to as “address”). In the sustain period, sustain pulse voltage is alternately applied to the display electrode pairs formed of the scan electrodes and the sustain electrodes, sustain discharge is caused in the discharge cell having undergone address discharge, and a phosphor layer of the corresponding discharge cell is light-emitted, thereby displaying an image.

As the screen size and definition of the panel have been further increased, and further improvement of the image display quality in a plasma display device has been demanded. Improving the luminance of a panel is an effective means for improving the image display quality, so that various studies of improving the luminous efficiency of the panel and improving the luminance have been performed. For example, a study of reducing the resistance value of the display electrode pairs to reduce the loss by the resistance component has been performed.

Additionally, cost reduction has been demanded. For example, in order to reduce the number of process by eliminating transparent electrodes, a study of using an electrode structure where an electrode is divided into a plurality of parts and an opening is disposed has been performed (e.g. patent document 1).

However, when material for reducing the loss by the electrode resistance is used or a plurality of display electrode pairs is used, the resistance value of the electrode decreases and the peak current of the scan electrode increases. As a result, when a sustain driving circuit component of large rated current must be used or such a component cannot be selected, the resistance value of the display electrode pairs must be increased or rising of pulses must be moderated, disadvantageously.

### CITATION LIST

[Patent Literature]

[Patent Literature 1] International Patent Publication No. 02/017345 brochure

### SUMMARY OF THE INVENTION

The plasma display device of the present invention has a panel and a sustain pulse generating circuit. The panel has a plurality of discharge cells including a display electrode pair that is formed of a scan electrode and a sustain electrode. The sustain pulse generating circuit has an electric power recovering circuit and a clamping circuit, generates as many sustain pulses as the number corresponding to the luminance weight in the sustain period of a plurality of subfields in one field period, and applies each sustain pulse to each display electrode pair. The electric power recovering circuit raises or falls a sustain pulse by resonating an inductor and the inter-electrode capacity of the display electrode pair. The clamping circuit clamps the voltage of the sustain pulse on a predetermined voltage. The sustain pulse generating circuit generates a predetermined number of second sustain pulse in the period after a first sustain pulse and before an erasing pulse. Here, the first sustain pulse occurs at the beginning of the sustain period, and the second sustain pulse is steeper than the rising gradient of the first sustain pulse. The sustain pulse generating circuit changes the rising gradient of the second sustain pulse for each subfield or each field in response to the light emitting rate of the panel in the sustain period.

Thus, peak current flowing in the scan electrode is suppressed, and the display luminance of each discharge cell can be uniformed.

In a panel driving method of the present invention, a panel is driven which has a plurality of discharge cells having a display electrode pair that is formed of a scan electrode and a sustain electrode. A plurality of subfields having an address period for selecting a discharge cell to cause discharge and a sustain period for applying as many sustain pulses as the number corresponding to the luminance weight to the discharge cell is disposed in one field period. In the period after the first sustain pulse, which occurs at the beginning of the sustain period, and before the erasing pulse, the predetermined number of second sustain pulse that are steeper than the rising gradient of a first sustain pulse are generated. The sustain pulse generating circuit changes the rising gradient of the second sustain pulse for each subfield or for each field in response to the light emitting rate of the panel in the sustain period.

Thus, peak current flowing in the scan electrode is suppressed, and the display luminance of each discharge cell can be uniformed.

### BRIEF DESCRIPTION OF DRAWINGS

FIG. 1 is an exploded perspective view showing a panel in accordance with an exemplary embodiment of the present invention.

FIG. 2 is a sectional view showing a structure of a discharge cell part of the panel.

FIG. 3 is an electrode array diagram of the panel.

FIG. 4 is a plan view showing a layout relationship among scan electrodes and sustain electrodes forming display electrode pairs, data electrodes, and barrier ribs in the panel.

FIG. 5A is a plan view illustrating a structure example of the scan electrodes and sustain electrodes of the discharge cell part of the panel.

FIG. 5B is a plan view illustrating another structure example of the scan electrodes and sustain electrodes of the discharge cell part of the panel.

FIG. 6A is a plan view illustrating yet another structure example of the scan electrodes and sustain electrodes of the discharge cell part of the panel.

FIG. 6B is a sectional view illustrating a front plate and a rear plate of the discharge cell part of the panel.

FIG. 7 is a sectional view illustrating a front plate and a rear plate of another example of the discharge cell part of the panel.

FIG. 8 is a plan view showing a schematic structure of the whole of the panel.

FIG. 9A is a plan view showing a layout example of a dummy electrode pattern of the panel.

FIG. 9B is a plan view showing another layout example of the dummy electrode pattern of the panel.

FIG. 10 is a plan view illustrating a non-display region of an end of the panel.

FIG. 11 is a plan view illustrating ends of the scan electrodes and sustain electrodes of the panel.

FIG. 12 is a block diagram showing the overall configuration of a plasma display device using the panel.

FIG. 13 is a waveform chart showing a driving voltage waveform to be applied to each electrode of the panel.

FIG. 14 is a circuit diagram of a sustain pulse generating circuit in accordance with the exemplary embodiment of the present invention.

FIG. 15 is a waveform chart showing first, second, and third sustain pulses in accordance with the exemplary embodiment of the present invention.

FIG. 16A is a schematic diagram showing the state where second sustain pulses are continuously generated at the end of the sustain period in accordance with the exemplary embodiment of the present invention.

FIG. 16B is a schematic diagram showing the state where third sustain pulses are continuously generated at the end of the sustain period in accordance with the exemplary embodiment of the present invention.

FIG. 17 is a diagram showing a relationship between light emitting rate and scan electrode current in accordance with the exemplary embodiment of the present invention.

FIG. 18 is a diagram showing a relationship between the light emitting rate and scan pulse voltage required for causing stable address discharge in accordance with the exemplary embodiment of the present invention.

### DETAILED DESCRIPTION OF PREFERRED EMBODIMENTS

### Exemplary Embodiment

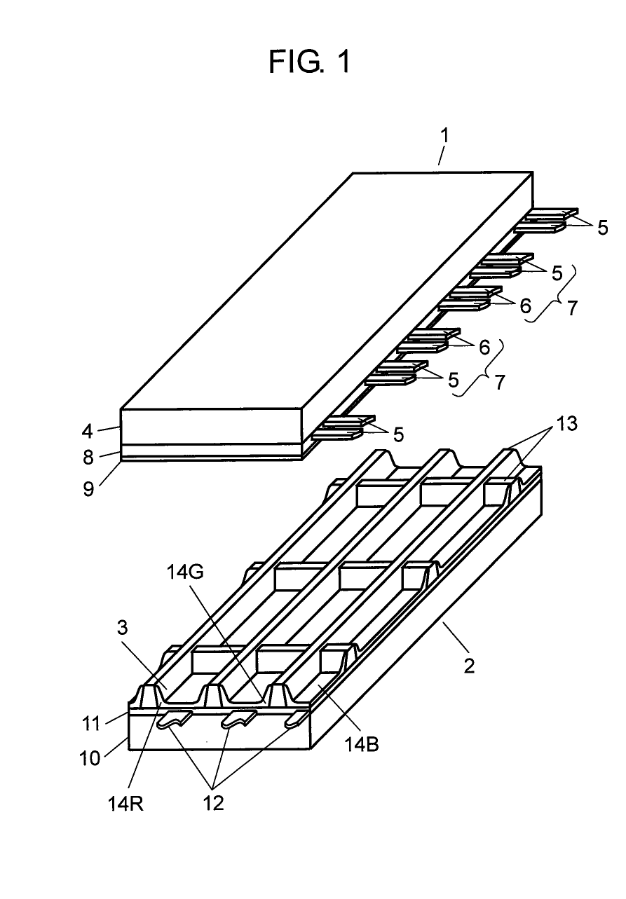

A plasma display device and a driving method of a panel in accordance with an exemplary embodiment of the present invention will be described hereinafter with reference to FIG. 1 through FIG. 18, but the exemplary embodiment of the present invention is not limited to this. First, the overall structure of the panel of the exemplary embodiment of the present invention is described using FIG. 1 through FIG.

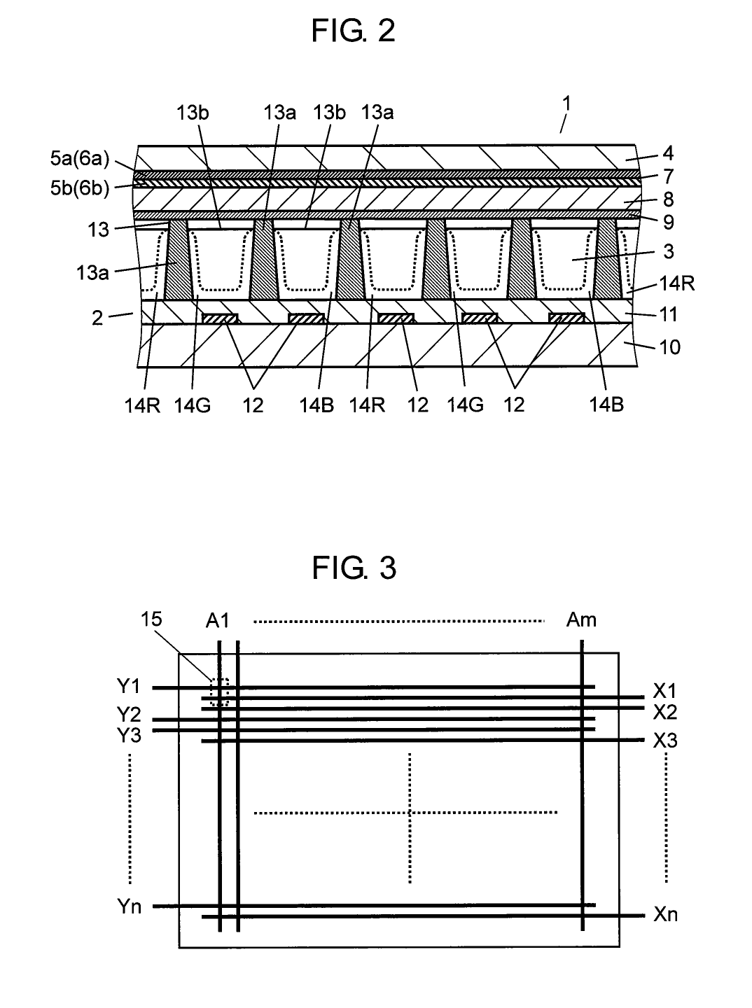

FIG. 1 is an exploded perspective view showing the panel of the exemplary embodiment of the present invention in a state where front plate 1 is separated from rear plate 2. FIG. 2 is a sectional view of the panel when front plate 1 is stuck to rear plate 2. As shown in FIG. 1 and FIG. 2, glass-made front plate 1 is faced to rear plate 2 in the panel so that discharge space 3 is formed between them.

Front plate 1 has scan electrode 5 as a conductive first electrode and sustain electrode 6 as a second electrode on glass-made substrate 4. Scan electrode 5 and sustain electrode 6 are arranged in parallel while a discharge gap is disposed between them, thereby forming display electrode pair 7. A plurality of display electrode pairs 7 is arranged on front plate 1 in the row direction of the panel. Dielectric layer 8 made of glass material is formed so as to cover scan electrodes 5 and sustain electrodes 6 of front plate 1, and protective film 9 made of MgO is formed on dielectric layer 8.

Scan electrodes 5 and sustain electrodes 6 are formed of only conductive electrodes that are made of silver (Ag) and have a thickness of about 5 μm without using transparent electrodes made of ITO (indium tin oxide) or the like. Each of scan electrodes 5 and sustain electrodes 6 has at least two-layer structure (two layers in FIG. 2), as shown in FIG. 2. Lower layers 5a and 6a on the substrate 4 side are made of material containing black-based metal oxide. Upper layers 5b and 6b are made of white-based material. The content of Ag in the white-based material is increased so that the specific resistance of upper layers 5b and 6b is smaller than that of lower layers 5a and 6a. Thus, lower layers 5a and 6a on the substrate 4 side are formed so that the brightness of them is lower than that of upper layers 5b and 6b. In other words, display electrode pairs 7 formed of scan electrodes 5 and sustain electrodes 6 are formed so that the brightness of display electrode pairs 7 is low when they are seen from the display surface of the substrate 4 side, thereby preventing a shielding member from existing between display electrode pairs 7.

Rear plate 2 has a plurality of silver (Ag)-made data electrodes 12 that is covered with insulator layer 11 made of glass material and arranged in a stripe shape in the column direction of the panel on glass-made substrate 10. In order to partition discharge space 3 between front plate 1 and rear plate 2 correspondingly to respective discharge cells 15, mesh barrier ribs 13 made of glass material, for example, are formed on insulator layer 11 of rear plate 2. Phosphor layers 14R, 14G, and 14B of red (R), green (G), and blue (B) are formed on the surface of insulator layer 11 and on side surfaces of barrier ribs 13.

Front plate 1 and rear plate 2 are faced to each other so that scan electrodes 5 and sustain electrodes 6 intersect with data electrodes 12. Discharge cells 15 are formed in the intersecting parts where scan electrodes 5 and sustain electrodes 6 intersect with data electrodes 12, as shown in FIG. 3. Discharge space 3 is filled with mixed gas of neon and xenon as discharge gas, for example. The structure of the panel is not limited to the above-mentioned one, but may have striped barrier ribs, for example.

As shown in FIG. 2, mesh barrier ribs 13 forming discharge cells 15 have longitudinal barrier rib 13a formed in parallel with data electrodes 12, and lateral barrier rib 13b that is orthogonal to longitudinal barrier rib 13a and is lower in height than longitudinal barrier rib 13a. Red, green, and blue phosphor layers 14R, 14G, and 14B that are applied to the inside of barrier ribs 13 are arranged in a stripe shape along longitudinal barrier ribs 13a in the repeating order of blue phosphor layer 14B, red phosphor layer 14R, green phosphor layer 14G.

FIG. 3 is an electrode array diagram of the panel shown in FIG. 1 and FIG. 2. The panel has n scan electrodes Y1, Y2, Y3, . . . , Yn (5 in FIG. 1) and n sustain electrodes X1, X2, X3, . . . , Xn (6 in FIG. 1) both extended in the row direction of the panel, and m data electrodes A1, . . . , Am (12 in FIG. 1) extended in the column direction. Discharge cell 15 is formed in the part where a pair of scan electrode Y1 and sustain electrode X1 intersect with one data electrode A1. Thus, mxn discharge cells 15 are formed in discharge space 3. Scan electrode Y1 and sustain electrode X1 are formed on front plate 1 in a repeating pattern of scan electrode Y1—sustain electrode X1—sustain electrode X2—scan electrode Y2 . . . as shown in FIG. 3. Each of these electrodes is connected to each connection terminal disposed at a peripheral end out of the image display region of front plate 1 and rear plate 2.

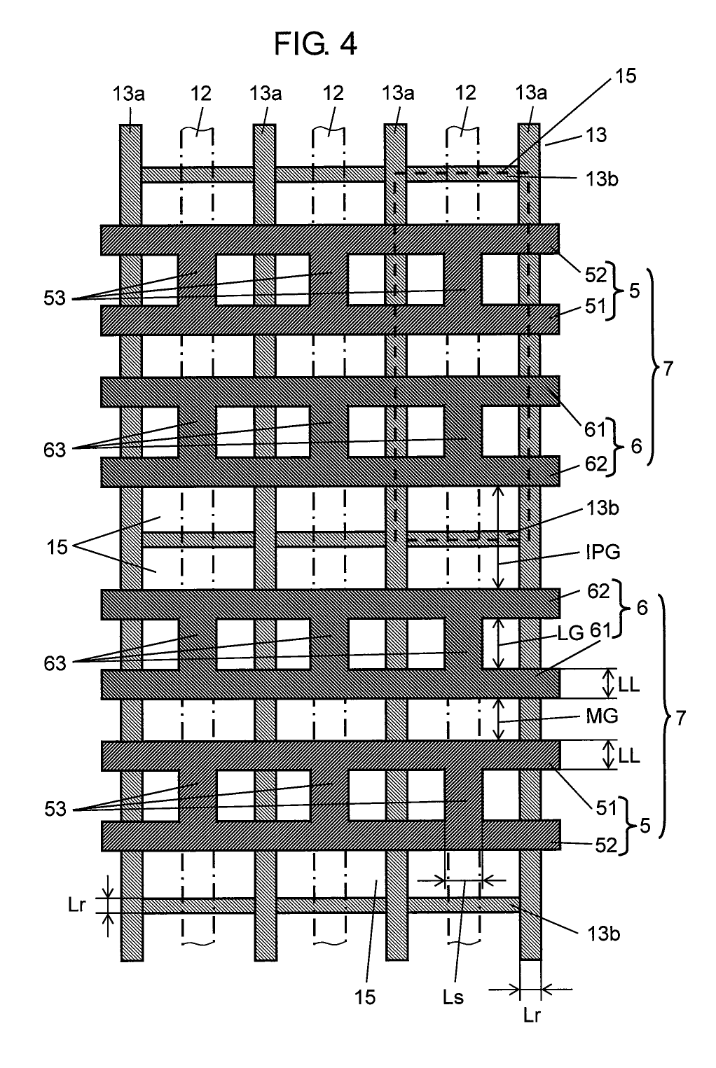

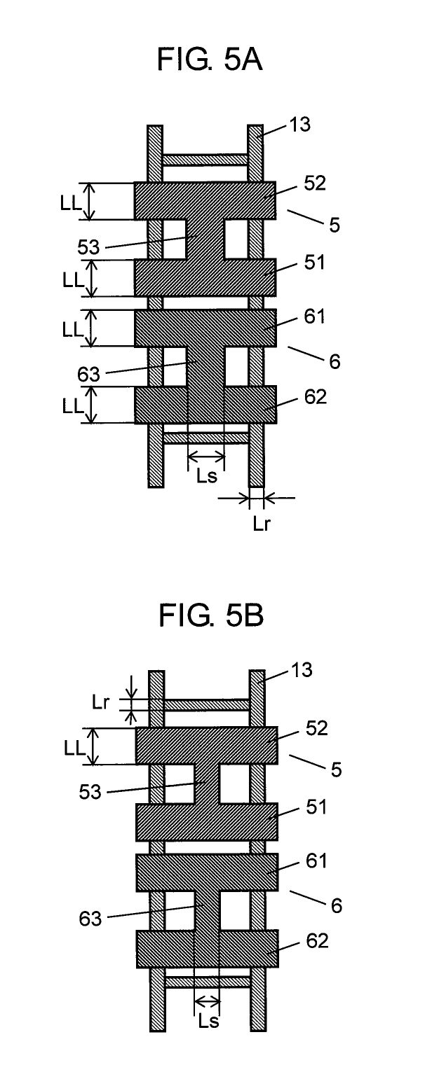

Next, the structure of the panel of display electrode pairs 7 of the present embodiment is described in more detail. Scan electrodes 5 and sustain electrodes 6 forming display electrode pairs 7 of front plate 1 are formed of only conductive electrodes that are made of conductive material such as silver (Ag) without using transparent electrodes made of ITO or the like. FIG. 4 is a plan view showing the layout relationship among scan electrodes 5 and sustain electrodes 6 forming display electrode pairs 7, data electrodes 12, and barrier ribs 13 in the panel of the present embodiment. FIG. 5A and FIG. 5B are plan views illustrating structure examples of scan electrode 5 and sustain electrode 6 of the discharge cell 15 part of the panel of the present embodiment.

As shown in FIG. 4, each of scan electrodes 5 and sustain electrodes 6 forming display electrode pairs 7 has a ladder shape. Each scan electrode 5 and each sustain electrode 6 have the following parts:
a first part including scan electrode 51 and sustain electrode 61 that are faced to each other via gap MG;
a second part including scan electrode 52 and sustain electrode 62 that are disposed in parallel while being spaced from scan electrode 51 and sustain electrode 61, respectively; and
a third part including scan electrodes 53 and sustain electrodes 63 that connect scan electrode 51 to scan electrode 52 and connect sustain electrode 61 to sustain electrode 62, respectively, and are disposed correspondingly to discharge cells 15.
   Scan electrode 5 and sustain electrode 6 are formed so as to satisfy Lr<Ls≦LL, where LL is the width of scan electrode 51 and sustain electrode 61 as the first part and scan electrode 52 and sustain electrode 62 as the second part, Ls is the width of scan electrode 53 and sustain electrode 63 as the third part, and Lr is the width of the top of each barrier rib 13. Specifically, width LL of scan electrode 51 and sustain electrode 61 as the first part and scan electrode 52 and sustain electrode 62 as the second part is about 60 to 70 μm, width Ls of scan electrode 53 and sustain electrode 63 as the third part is about 60 μm, and width Lr of the top of each barrier rib 13 is about 50 μm. Discharge gap MG between scan electrode 5 and sustain electrode 6 is about 90 to 100μm. Gap LG between the first part including scan electrode 51 and sustain electrode 61 and the second part including scan electrode 52 and sustain electrode 62 of scan electrode 5 and sustain electrode 6 is about 80 μm. Thus, discharge gap MG and gap LG are set to be narrower than non-discharge gap IPG (about 200 μm) between adjacent discharge cells 15.

FIG. 5A shows an example when Lr<Ls=LL in scan electrode 5 and sustain electrode 6. In other words, the width of scan electrode 51 and sustain electrode 61 as the first part and scan electrode 52 and sustain electrode 62 as the second part is the same as that of scan electrode 53 and sustain electrode 63 as the third part, and is greater than width Lr of the top of barrier rib 13. FIG. 5B shows an example when Lr<Ls<LL in scan electrode 5 and sustain electrode 6. In other words, the width of scan electrode 51 and sustain electrode 61 as the first part and scan electrode 52 and sustain electrode 62 as the second part is greater than that of scan electrode 53 and sustain electrode 63 as the third part, and is greater than width Lr of the top of barrier rib 13.

Thus, scan electrode 5 and sustain electrode 6 are formed so as to satisfy Lr<Ls≦LL, where LL is the width of scan electrode 51 and sustain electrode 61 as the first part and scan electrode 52 and sustain electrode 62 as the second part, Ls is the width of scan electrode 53 and sustain electrode 63 as the third part, and Lr is the width of the top of barrier rib 13. This structure can inexpensively provide a panel having a display performance securing sufficient contrast ratio even when no shielding member is disposed between adjacent discharge cells 15. In a general panel, a glass material of a relatively high brightness is employed as a material constituting barrier ribs 13, so that the sufficient contrast ratio is secured by disposing a shielding member in non-discharge gap IPG between adjacent discharge cells 15.

In the present embodiment, however, scan electrodes 5 and sustain electrodes 6 forming display electrode pairs 7 whose brightness is low when they are seen from the display surface side have the following parts:
the first part including scan electrode 51 and sustain electrode 61 that are faced to each other via gap MG;
the second part including scan electrode 52 and sustain electrode 62 that are disposed in parallel while being spaced from scan electrode 51 and sustain electrode 61, respectively; and
the third part including scan electrodes 53 and sustain electrodes 63 that connect scan electrode 51 and sustain electrode 61 as the first part to scan electrode 52 and sustain electrode 62 as the second part, respectively, and are disposed for each discharge cell 15.
   Scan electrodes 5 and sustain electrodes 6 are formed so as to satisfy Lr<Ls≦LL, where LL is the width of scan electrode 51 and sustain electrode 61 as the first part to scan electrode 52 and sustain electrode 62 as the second part, Ls is the width of scan electrode 53 and sustain electrode 63 as the third part, and Lr is the width of the top of barrier rib 13. This structure can provide a panel having the display performance securing the sufficient contrast ratio similarly to the case having a shielding member even when no shielding member is disposed in the part of non-discharge gap IPG between adjacent discharge cells 15.

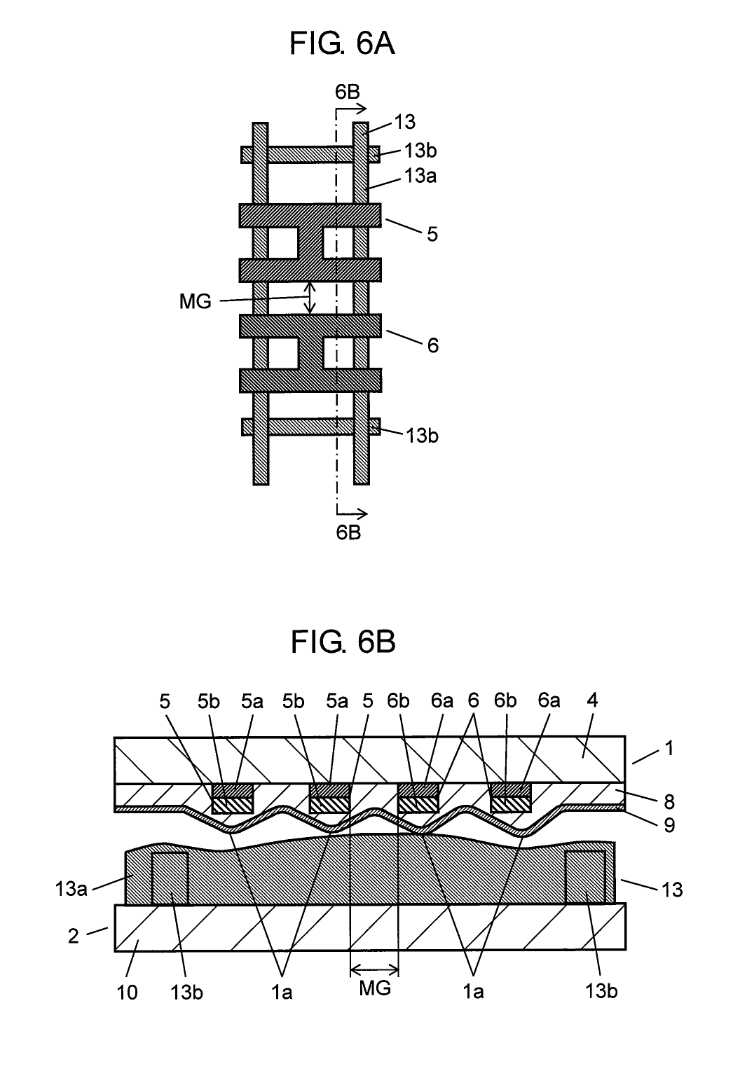

Next, the state of the part of each display electrode pair 7 when front plate 1 is stuck to rear plate 2 in the panel of the present embodiment is described. FIG. 6A is a plan view illustrating a structure example of scan electrode 5 and sustain electrode 6 of discharge cells 15 in the panel of the present embodiment. FIG. 6B is a sectional view taken in the line 6B-6B of FIG. 6A, and illustrates the state of the discharge cell 15 part.

As shown in FIG. 6A and FIG. 6B, front plate 1 abuts on the top of barrier ribs 13 of rear plate 2 in a part other than discharge gap MG in the panel of the present embodiment. In the present embodiment, each display electrode pair 7 formed of scan electrode 5 and sustain electrode 6 is formed of only upper layer 5b and lower layer 5a of conductive electrodes that are made of silver (Ag) without using transparent electrodes made of ITO or the like. Further, scan electrodes 5 and sustain electrodes 6 forming display electrode pairs 7 have the following parts:
the first part including scan electrode 51 and sustain electrode 61 that are faced to each other via discharge gap MG;
the second part including scan electrode 52 and sustain electrode 62 that are disposed in parallel while being spaced from scan electrode 51 and sustain electrode 61, respectively; and
the third part including scan electrodes 53 and sustain electrodes 63 that connect scan electrode 51 and sustain electrode 61 as the first part to scan electrode 52 and sustain electrode 62 as the second part, respectively, and are disposed for each discharge cell 15.
   Then, dielectric layer 8 is formed so as to cover display electrode pairs 7 and protective film 9 is formed, thereby forming rising sections la on the surface of the discharge space side of front plate 1 so as to correspond to scan electrode 51 and sustain electrode 61 as the first part and scan electrode 52 and sustain electrode 62 as the second part. Here, scan electrode 51 and sustain electrode 61 are faced to each other via gap MG, and scan electrode 52 and sustain electrode 62 are disposed in parallel while being spaced from scan electrode 51 and sustain electrode 61, respectively. Thus, barrier ribs 13 on the rear plate 2 side, especially longitudinal barrier ribs 13a, abut on rising sections la other than discharge gaps MG. Therefore, when front plate 1 is stuck to rear plate 2, mechanical stress is seldom applied to barrier ribs 13 in the discharge gap MG part, and hence notches of barrier ribs 13 in the discharge gap MG part can be reduced to reduce occurrence of a failure.

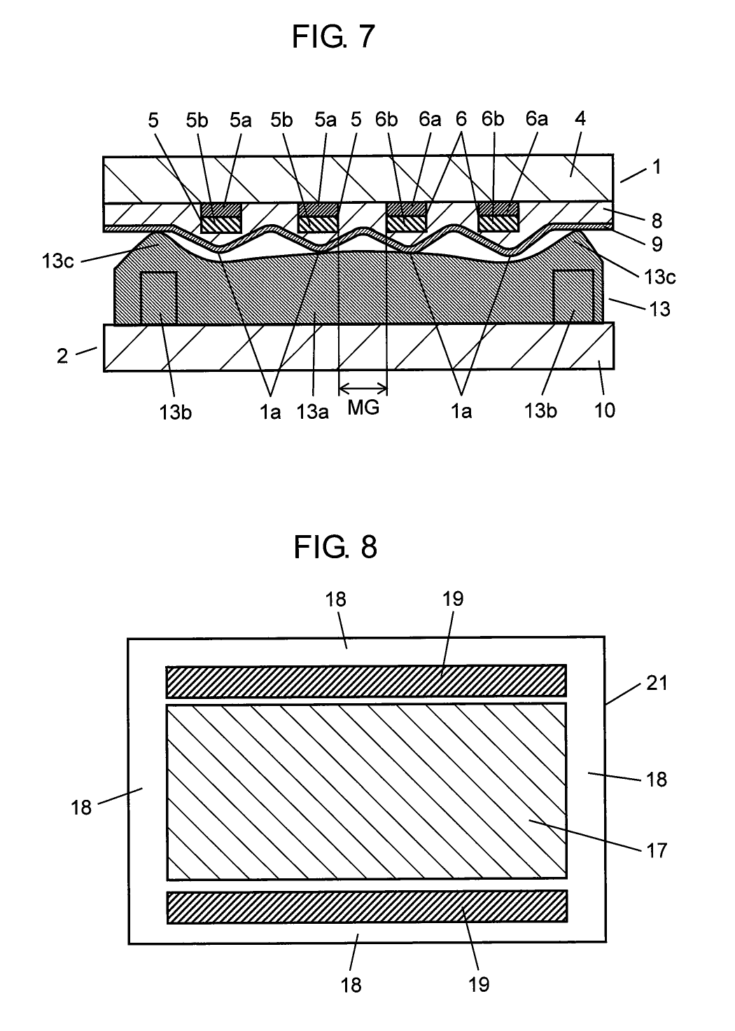

As shown in FIG. 7, another sectional view of the panel may be employed. In other words, rising sections 13c are disposed in the intersecting parts of longitudinal barrier ribs 13a and lateral barrier ribs 13b of barrier ribs 13 on the rear plate 2 side, and barrier ribs 13 abut on front plate 1 at rising sections 13c. Thus, notches of barrier ribs 13 in the discharge gap MG part of display electrode pairs 7 can be further reduced, and occurrence of a failure due to the notches of barrier ribs 13 can be reduced.

Next, a structure of the non-display region of front plate 1 and a structure of an electrode drawing part for connecting display electrode pairs 7 to an external driving circuit in the panel of the present embodiment are described.

FIG. 8 is a plan view showing a schematic structure of the whole of panel 21 in the present embodiment of the present invention. Panel 21 has display region 17 and non-display region 18 as shown in FIG. 8. An image corresponding to an input image signal is displayed in display region 17. Non-display region 18 exists around display region 17. Non-display region 18 exists between display region 17 and a sealing section (not shown) for sealing peripheries of front plate 1 and rear plate 2. The outside part of the sealing section in panel 21 is provided with a terminal part (not shown) to be connected to the external driving circuit.

Dummy electrode patterns 19 are formed in non-display region 18. Dummy electrode patterns 19 are formed in upper and lower parts of the row direction of front plate 1 in non-display region 18, are made of the same material as scan electrodes 5 and sustain electrodes 6, and have pattern shapes wider than the width of the row direction of scan electrodes 5 and sustain electrodes 6. Additionally, dummy electrode patterns 19 are formed in an electrically floating state.

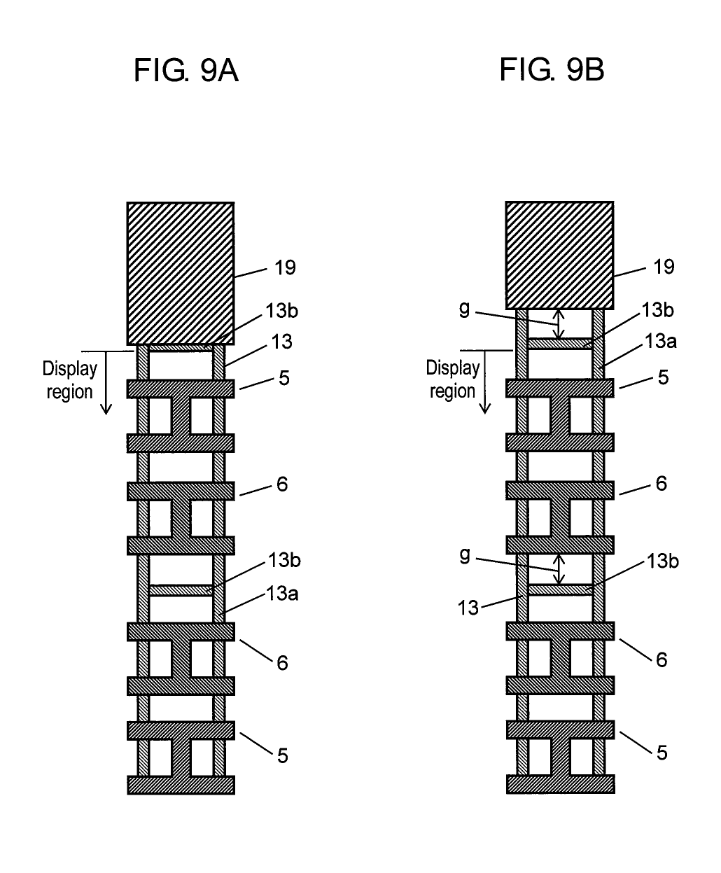

FIG. 9A and FIG. 9B are plan views showing layout examples of dummy electrode pattern 19 of the panel. As shown in FIG. 9A, dummy electrode pattern 19 is formed so that ends of the width direction of display region 17 exist at positions matching with barrier ribs 13 of the row direction in the boundary between display region 17 and non-display region 18, namely with lateral barrier rib 13b. As shown in FIG. 9B, dummy electrode pattern 19 may be formed so that ends of the width direction of the display region 17 side are separated from barrier rib 13 of the row direction in the boundary between display region 17 and non-display region 18, namely from lateral barrier rib 13b, by the same interval (g) as interval (g) from scan electrode 5 and sustain electrode 6 to lateral barrier rib 13b

Thus, in plasma display panel 21 of the present embodiment, dummy electrode patterns 19 are formed in upper and lower parts of the row direction of front plate 1 in non-display region 18, are made of the same material as scan electrodes 5 and sustain electrodes 6, and have pattern shapes wider than the width of the row direction of scan electrodes 5 and sustain electrodes 6. Additionally, dummy electrode patterns 19 are formed in an electrically floating state. Therefore, the contrast ratio between non-display region 18 and display region 17 where image display is performed by discharge light emission increases, and the display performance of whole panel 21 can be improved.

When panel 21 is actually prepared and image display is performed, the following fact is recognized. The contrast ratio between display region 17 and non-display region 18 can be increased when dummy electrode patterns 19 are formed so that ends of the width direction of display region 17 exist at positions matching with barrier ribs 13 of the row direction in the boundary between display region 17 and non-display region 18, namely with lateral barrier rib 13b. Therefore, this structure is further effective in improving the display performance of whole panel 21.

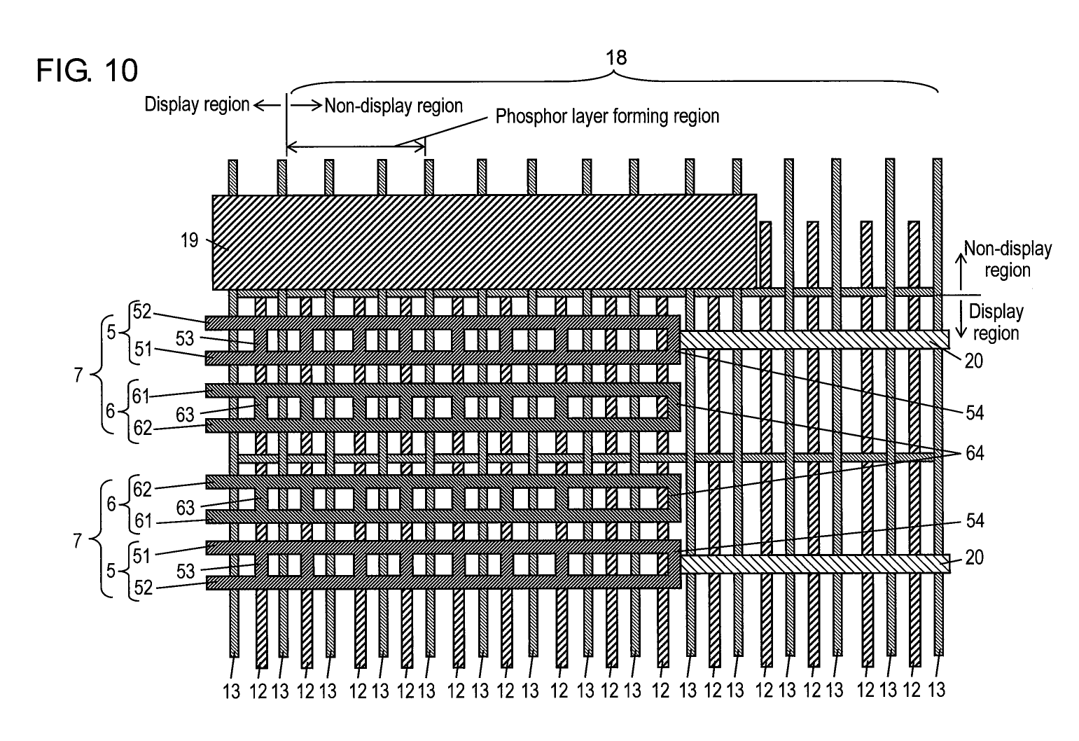

Next, a structure of the electrode drawing part for connecting display electrode pairs 7 to the external driving circuit in plasma display panel 21 of the present embodiment is described. FIG. 10 is a plan view illustrating the state of the electrode drawing part side for connecting display electrode pairs 7 to the external driving circuit, namely the state of non-display region 18 of an end of panel 21 in the row direction, in plasma display panel 21 in accordance with the exemplary embodiment of the present invention. FIG. 10 shows only display electrode pairs 7, data electrodes 12, barrier ribs 13, and dummy electrode pattern 19. As shown in FIG. 10, in non-display region 18 at an end of panel 21 of the row direction, a plurality of data electrodes 12 and a plurality of barrier ribs 13 are arranged in a repeating pattern similar to display region 17. Phosphor layer forming regions are formed in the array similar to that of display region 17 between several (three in FIG. 10) barrier ribs 13 on the display region 17 side, of the plurality of barrier ribs 13.

As shown in FIG. 10, scan electrodes 51 and sustain electrodes 61 as the first part and scan electrodes 52 and sustain electrodes 62 as the second part of scan electrodes 5 and sustain electrodes 6 forming display electrode pairs 7 are extended to non-display region 18 of the row direction in a state where they are faced to each other via the discharge gaps. Several scan electrodes 53 and sustain electrodes 63 as the third part for connecting scan electrodes 51 and sustain electrodes 61 as the first part to scan electrodes 52 and sustain electrodes 62 as the second part are disposed as in display region 17. Ends of scan electrodes 51 and sustain electrodes 61 as the first part and scan electrodes 52 and sustain electrodes 62 as the second part that are extended to non-display region 18 have scan electrodes 54 and sustain electrodes 64 for connecting scan electrodes 51 and sustain electrodes 61 as the first part to scan electrodes 52 and sustain electrodes 62 as the second part. Wiring pattern 20 drawn to the end outside the sealing section of front plate 1 is connected to scan electrodes 54 in order to be connected to the external driving circuit. Further, dummy electrode patterns 19 are formed so that the ends of the pattern are extended to the position outside scan electrodes 54 and sustain electrodes 64. FIG. 10 shows only the scan electrode 5 side, but the sustain electrode 6 side has a similar structure.

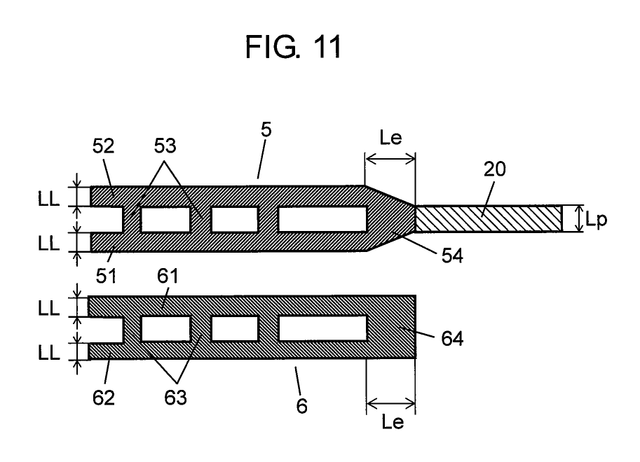

FIG. 11 is a plan view illustrating the end that is extended to non-display region 18 of scan electrodes 5 and sustain electrodes 6 in FIG. 10. As shown in FIG. 11, scan electrodes 5 and sustain electrodes 6 of the present embodiment are formed so that width Lp is greater than width LL, where LL is the width of scan electrodes 51 and 52 and sustain electrodes 61 and 62, and Lp is the width of wiring pattern 20. Specifically, when width LL of scan electrodes 51, sustain electrodes 61, scan electrodes 52, and sustain electrodes 62 is set to about 60 μm, width Lp of wiring pattern 20 is set to about 80 μm.

In the present embodiment, scan electrode 54 for connecting between the ends of scan electrode 51 and scan electrode 52 extended to non-display region 18 and sustain electrode 64 for connecting between the ends of sustain electrode 61 and sustain electrode 62 extended to non-display region 18 are disposed in scan electrode 5 and sustain electrode 6. Wiring pattern 20 having a width greater than width LL of scan electrodes 51, sustain electrodes 61, scan electrodes 52, and sustain electrodes 62 is connected to scan electrode 54 and sustain electrode 64. Therefore, scan electrode 5 and sustain electrode 6 can be reliably connected to wiring pattern 20. As a result, occurrence of a failure of panel 21 can be suppressed.

In the example of FIG. 11, width Lp of wiring pattern 20 is greater than width LL of scan electrode 51, sustain electrode 61, scan electrode 52, and sustain electrode 62. According to the result of inventor's trail, however, reliability of the connecting part can be secured even when width Lp of wiring pattern 20 is the same as width LL of scan electrode 51, sustain electrode 61 scan electrode 52, and sustain electrode 62. Therefore, width Lp of wiring pattern 20 and width LL of scan electrode 51, sustain electrode 61, scan electrode 52, and sustain electrode 62 are set so that LL≦Lp.

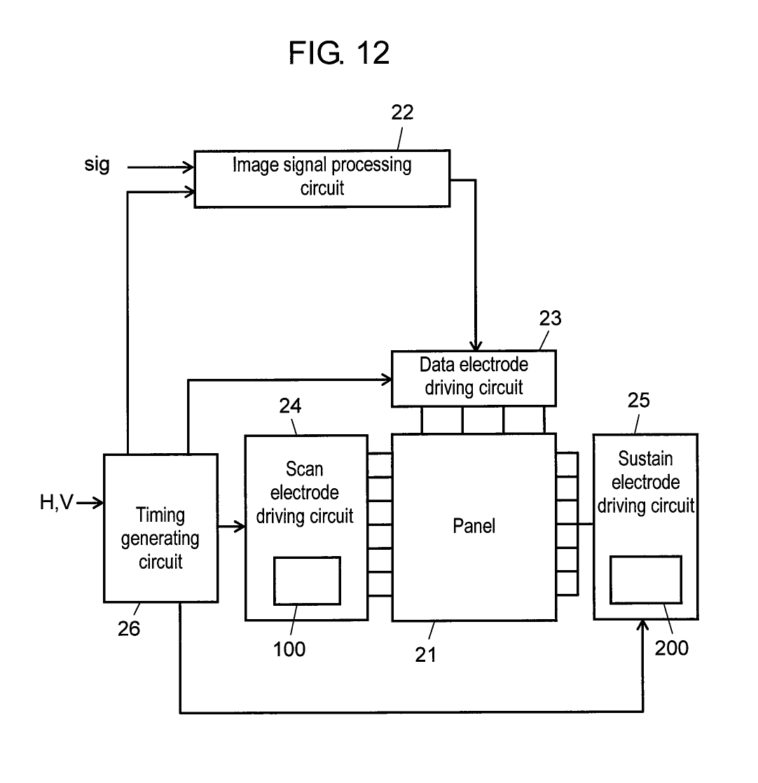

Next, the overall configuration and driving method of a plasma display device using panel 21 is described. FIG. 12 is a block diagram showing the overall configuration of the plasma display device in accordance with the exemplary embodiment of the present invention. The plasma display device has the following elements:
panel 21 shown in FIG. 1 through FIG. 3;
image signal processing circuit 22;
data electrode driving circuit 23;
scan electrode driving circuit 24;
sustain electrode driving circuit 25;
timing generating circuit 26; and
a power supply circuit (not shown).
   Data electrode driving circuit 23 is connected to one end of each data electrode 12 of panel 21, and has a plurality of data drivers formed of semiconductor elements for applying voltage to data electrodes 12. Data electrodes 12 are divided into a plurality of blocks each of which includes several data electrodes 12. A plurality of data drivers for each block is connected to the electrode drawing section of the lower end of panel 21.

In FIG. 12, image signal processing circuit 22 converts an input image signal sig into image data of each subfield. Data electrode driving circuit 23 converts the image data of each subfield into a signal corresponding to each of data electrodes A1 through Am, and drives each of data electrodes A1 through Am. Timing generating circuit 26 generates various timing signals based on horizontal synchronizing signal H and vertical synchronizing signal V, and supplies them to respective driving circuit blocks. Scan electrode driving circuit 24 has sustain pulse generating circuit 100 for supplying a driving voltage waveform to scan electrodes Y1 through Yn based on the timing signals. Sustain electrode driving circuit 25 has sustain pulse generating circuit 200 for supplying a driving voltage waveform to sustain electrodes X1 through Xn based on the timing signals. The configuration and operation of sustain pulse generating circuit 100 and sustain pulse generating circuit 200 are described in detail later. Sustain electrodes X1 through Xn are connected commonly inside panel 21 or outside panel 21, and the common connecting wire is connected to sustain electrode driving circuit 25.

Next, the driving voltage waveform and operation for driving panel 21 are described. The plasma display device of the present embodiment performs gradation display by a subfield method. In this subfield method, one field period is divided into a plurality of subfields, and gradation display is performed by controlling light emission or no light emission of each discharge cell 15 in each subfield. Each subfield has an initializing period, an address period, and a sustain period.

In each subfield, in the initializing period, initializing discharge is caused, a wall charge required for address discharge in the subsequent address period is formed on each electrode, and a priming particle (an excitation particle as an initiating agent for discharge) for reducing discharge delay and stably causing address discharge is generated. The initializing operation at this time includes all-cell initializing operation of causing the initializing discharge in all discharge cells 15, and selective initializing operation of selectively causing the initializing discharge only in discharge cell 15 that has undergone sustain discharge in the immediately preceding subfield.

In the address period, address discharge is caused selectively in discharge cell 15 to emit light in the subsequent sustain period, thereby forming wall charge. In the sustain period, as many sustain pulses as the number proportional to the luminance weight are alternately applied to display electrode pairs 7, and sustain discharge is caused in discharge cell 15 having undergone address discharge, thereby emitting light.

The proportionality factor is referred to as “luminance magnification”.

In the present embodiment, one field is divided into 10 subfields (first SF, second SF, . . . , 10th SF), and respective subfields have luminance weights of 1, 2, 3, 6, 11, 18, 30, 44, 60, and 80. The all-cell initializing operation is performed in the initializing period of the first SF, and the selective initializing operation is performed in the initializing period of the second SF through 10th SF. Thus, light emission related to no image display is only light emission following the discharge of the all-cell initializing operation in the first SF. The luminance of black level, which is luminance in a black display region that does not cause sustain discharge, is therefore determined only by weak light emission in the all-cell initializing operation. This allows image display of sharp contrast. In the sustain period in each subfield, as many sustain pulses as the number derived by multiplying the luminance weight of each subfield by a predetermined luminance magnification are applied to each of display electrode pairs 7.

In the present embodiment, the number of subfield and luminance weight of each subfield are not limited to the above-mentioned values. The subfield structure is changed based on an image signal or the like.

In the present embodiment, a ramp waveform voltage is generated at the end of the sustain period, and thus address operation in the address period of the subsequent subfield is stabilized. A summary of the ramp waveform voltage is firstly described, and then the configuration of the driving circuit is described.

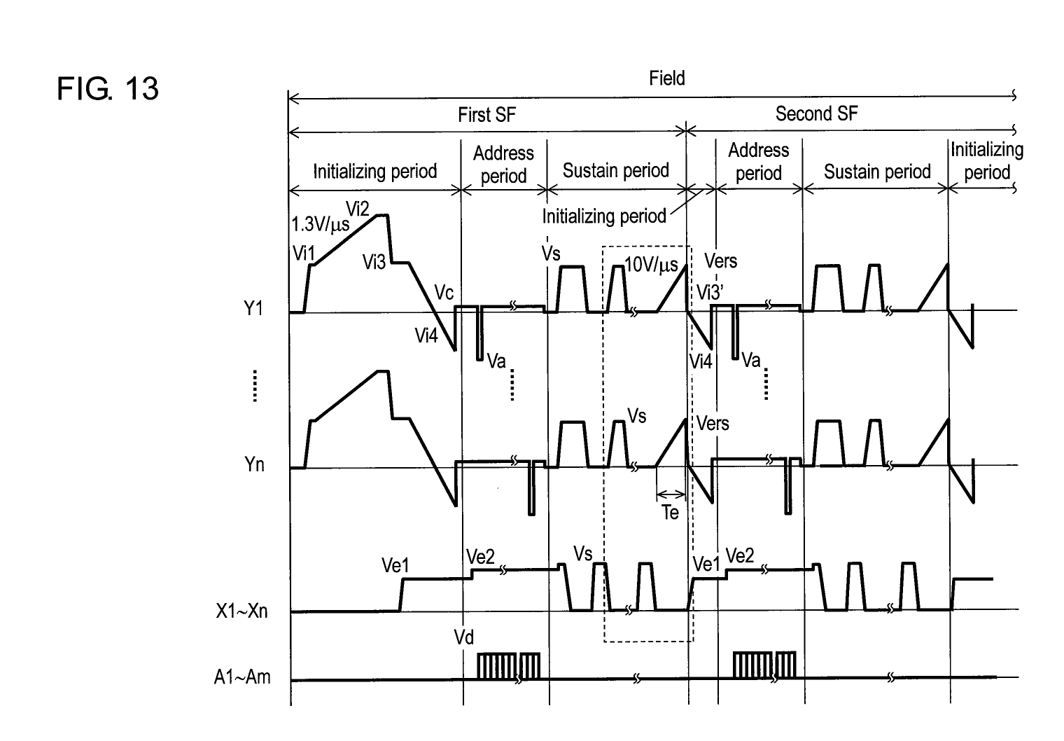

FIG. 13 is a driving voltage waveform chart to be applied to each electrode of panel 21 in accordance with the exemplary embodiment of the present invention. FIG. 13 shows driving voltage waveforms of two subfields:
a subfield for performing all-cell initializing operation (hereinafter referred to as “all-cell initializing subfield”); and
a subfield for performing selective initializing operation (hereinafter referred to as “selective initializing subfield”).
   The driving voltage waveforms in the other subfields are substantially similar to these. Scan electrode Yi, sustain electrode Xi, and data electrode Ak described later are selected based on image data from scan electrodes, sustain electrodes, and data electrodes, respectively.

First, a first subfield (first SF) as the all-cell initializing subfield is described. In the first half of the initializing period of the first SF, 0 (V) is applied to data electrodes A1 through Am and sustain electrodes X1 through Xn, and a first ramp waveform voltage (hereinafter referred to as “up-ramp waveform voltage”) is applied to scan electrodes Y1 through Yn. Here, the up-ramp waveform voltage gradually rises from voltage Vii, which is not higher than a discharge start voltage, to voltage Vi2, which is higher than the discharge start voltage, with respect to sustain electrodes X1 through Xn.

In the present embodiment, the gradient of the up-ramp waveform voltage is set to about 1.3 V/μsec. While the up-ramp voltage rises, feeble initializing discharge continuously occurs between scan electrodes Y1 through Yn and sustain electrodes X1 through Xn, and feeble initializing discharge continuously occurs between scan electrodes Y1 through Yn and data electrodes Al through Am. Negative wall voltage is accumulated on scan electrodes Y1 through Yn, and positive wall voltage is accumulated on data electrodes A1 through Am and sustain electrodes X1 through Xn. The wall voltages on the electrodes mean voltages generated by wall charge accumulated on dielectric layer 8 for covering scan electrodes 5 and sustain electrodes 6, protective layer 9, and phosphor layers 14.

In the latter half of the initializing period, positive voltage Ve1 is applied to sustain electrodes X1 through Xn, and 0 (V) is applied to data electrodes A1 through Am. A ramp waveform voltage (hereinafter referred to as “down-ramp waveform voltage”) is applied to scan electrodes Y1 through Yn. Here, the down-ramp waveform voltage gradually falls from voltage Vi3, which is not higher than the discharge start voltage, to voltage Vi4, which is higher than the discharge start voltage, with respect to sustain electrodes X1 through Xn. While down-ramp waveform voltage falls, feeble initializing discharge occurs continuously between scan electrodes Y1 through Yn and sustain electrodes X1 through Xn, and feeble initializing discharge continuously occurs between scan electrodes Y1 through Yn and data electrodes A1 through Am. The negative wall voltage on scan electrodes Y1 through Yn and the positive wall voltage on sustain electrodes X1 through Xn are reduced, and positive wall voltage on data electrodes A1 through Am is adjusted to a value appropriate for address operation. The all-cell initializing operation of applying initializing discharge to all discharge cells 15 is thus completed.

As shown in the initializing period of the second SF of FIG. 13, a driving voltage waveform where the first half of the initializing period is omitted may be applied to each electrode. In other words, voltage Ve1 is applied to sustain electrodes X1 through Xn, 0 (V) is applied to data electrodes A1 through Am, and a down-ramp waveform voltage that gradually falls from voltage Vi3′ to voltage Vi4 is applied to scan electrodes Y1 through Yn. Thus, feeble initializing discharge occurs in discharge cell 15 having undergone sustain discharge in the sustain period in the preceding subfield, and wall voltage on scan electrode Yi and sustain electrode Xi is reduced. In discharge cell 15 where sufficient positive wall voltage is accumulated on data electrodes Ak (k is 1 through m) by the immediately preceding sustain discharge, excessive part of the wall voltage is discharged to adjust the wall voltage to a value appropriate for address operation.

In discharge cell 15 having undergone no sustain discharge in the preceding subfield, discharge does not occur, and the wall charge at the end of the initializing period in the preceding subfield is kept as it is. Thus, the initializing operation where the first half is omitted is a selective initializing operation of causing the initializing discharge in discharge cell 15 that has undergone sustain operation in the sustain period in the immediately preceding subfield.

In the subsequent address period, firstly voltage Ve2 is applied to sustain electrodes X1 through Xn, and voltage Vc is applied to scan electrodes Y1 through Yn.

Then, negative scan pulse voltage Va is applied to scan electrode Y1 of the first row, and positive address pulse voltage Vd is applied to data electrode Ak (k is 1 through m) in discharge cell 15 to emit light in the first row, among data electrodes A1 through Am. At this time, the voltage difference in the intersecting part of data electrode Ak and scan electrode Y1 is obtained by adding the difference between the wall voltage on data electrode Ak and that on scan electrode Y1 to difference (Vd-Va) between the external applied voltages, and exceeds the discharge start voltage. Thus, discharge occurs between data electrode Ak and scan electrode Y1. Since voltage Ve2 is applied to sustain electrodes X1 through Xn, the voltage difference between sustain electrode X1 and scan electrode Y1 is obtained by adding the difference between the wall voltage on sustain electrodes X1 and that on scan electrode Y1 to difference (Ve2-Va) between the external applied voltages.

In this case, when voltage Ve2 is set to a voltage value slightly lower than the discharge start voltage, the state between sustain electrode X1 and scan electrode Y1 can be set so that discharge does not occur but is apt to occur. Thus, using discharge occurring between data electrode Ak and scan electrode Y1, discharge can be caused between sustain electrode X1 and scan electrode Y1 that are disposed in a region intersecting with data electrode Ak. Thus, address discharge occurs in discharge cell 15 to emit light, positive wall voltage is accumulated on scan electrode Y1, negative wall voltage is accumulated on sustain electrode X1, and negative wall voltage is also accumulated on data electrode Ak.

Thus, address operation of causing address discharge in discharge cell 15 to emit light in the first row and of accumulating wall voltage on each electrode is performed. While, the voltage in the intersection part of scan electrode Y1 and data electrodes A1 through Am that have not undergone address pulse voltage Vd does not exceed the discharge start voltage, so that address discharge does not occur. The above-mentioned address operation is performed until discharge cell 15 of the n-th row, and the address period is completed.

In the sustain period, positive sustain pulse voltage Vs is firstly applied to scan electrodes Y1 through Yn, and the ground potential as a base potential, namely 0(V), is applied to sustain electrodes X1 through Xn. In discharge cell 15 having undergone the address discharge in the immediately preceding address period, the voltage difference between scan electrode Yi and sustain electrode Xi is obtained by adding the difference between the wall voltage on scan electrode Yi and that on sustain electrode Xi to sustain pulse voltage Vs, and exceeds the discharge start voltage.

Then, sustain discharge occurs between scan electrode Yi and sustain electrode Xi, and ultraviolet rays generated at this time cause red, green, and blue phosphor layers 14R, 14G, and 14B to emit light. Negative wall voltage is accumulated on scan electrode Yi, and positive wall voltage is accumulated on sustain electrode Xi. Positive wall voltage is also accumulated on data electrode Ak. In discharge cell 15 where address discharge has not occurred in the address period, sustain discharge does not occur and the wall voltage at the end of the initializing period is kept.

Subsequently, 0 (V) as the base potential is applied to scan electrodes Y1 through Yn, and sustain pulse voltage Vs is applied to sustain electrodes X1 through Xn. In discharge cell 15 having undergone the sustain discharge, the voltage difference between sustain electrode Xi and scan electrode Yi exceeds the discharge start voltage, so that sustain discharge occurs between sustain electrode Xi and scan electrode Yi again. Therefore, negative wall voltage is accumulated on sustain electrode Xi, and positive wall voltage is accumulated on scan electrode Yi. Hereinafter, similarly, as many sustain pulses as the number derived by multiplying the luminance weight by luminance magnification are alternately applied to scan electrodes Y1 through Yn and sustain electrodes X1 through Xn to cause potential difference between the electrodes of display electrode pairs 7. Thus, sustain discharge is continuously performed in discharge cell 15 where the address discharge has been caused in the address period.

At the end of the sustain period, a second ramp waveform voltage (hereinafter referred to as “erasing ramp waveform voltage”) that gradually rises from 0 (V) as the base potential to voltage Vers is applied to scan electrodes Y1 through Yn. Thus, feeble discharge is continuously caused, and a part or the whole of the wall voltage on scan electrode Yi and sustain electrode Xi is erased while positive wall voltage is kept on data electrode Ak,

Specifically, sustain electrodes X1 through Xn are returned to 0 (V), then the erasing ramp waveform voltage as the second ramp waveform voltage is generated at a gradient steeper than that of the up-ramp waveform voltage as the first ramp waveform voltage, for example at a gradient of about 10 V/μsec, and is applied to scan electrodes Y1 through Yn. Here, erasing ramp voltage rises from 0 (V) as the base potential to voltage Vers, which is higher than the discharge start voltage. Thus, feeble discharge is caused between sustain electrode Xi and scan electrode Yi in discharge cell 15 having undergone the sustain discharge. This feeble discharge continuously occurs while the voltage applied to sustain electrodes X1 through Xn rises. When the erasing voltage reaches voltage Vers as a predetermined voltage, the voltage applied to scan electrodes Y1 through Yn is fallen to 0 (V) as the base potential.

Then, charged particles generated by the feeble discharge are always accumulated on sustain electrode Xi and scan electrode Yi to produce wall charge so as to reduce the voltage difference between sustain electrode Xi and scan electrode Yi. Thus, while positive wall charge is left on data electrode Ak, the wall voltage between scan electrodes Y1 through Yn and sustain electrodes X1 through Xn is decreased to the extent of the difference between the voltage applied to scan electrode Yi and the discharge start voltage, namely (voltage Vers—discharge start voltage). Hereinafter, the final discharge in the sustain period caused by the erasing ramp waveform voltage is referred to as “erasing discharge”.

Operation in the subsequent subfield is substantially the same as the above-mentioned operation except for the number of sustain pulse in the sustain period, and hence is not described. The outline of the driving voltage waveform applied to each electrode of panel 21 of the present embodiment has been described.

Next, the driving method of panel 21 of the present embodiment is described.

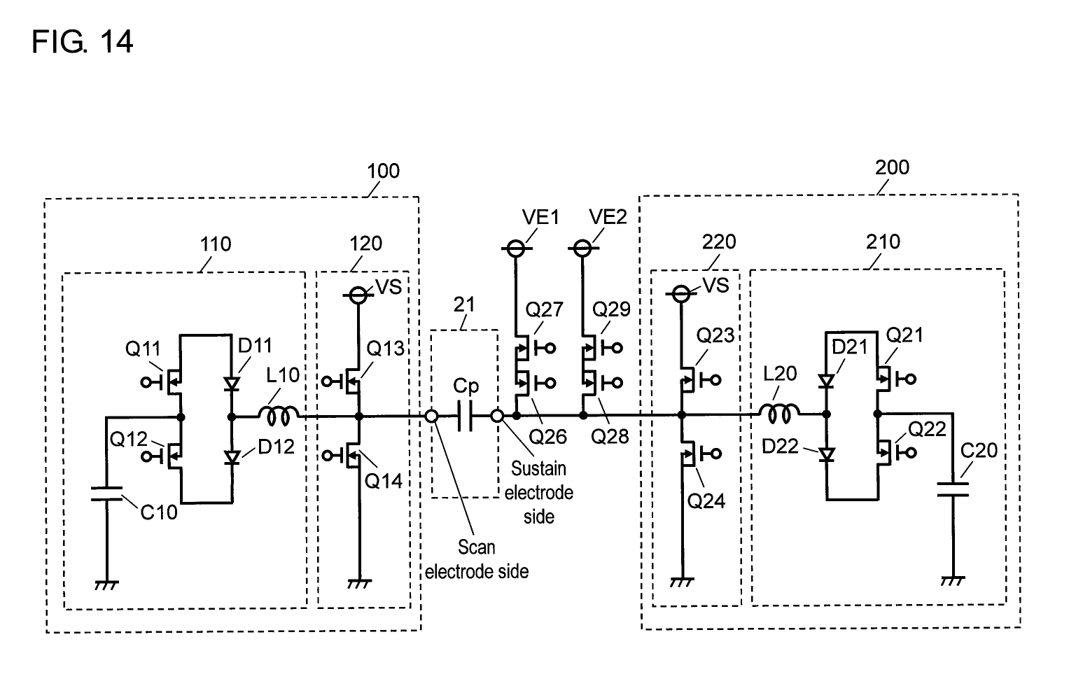

FIG. 14 is a circuit diagram of sustain pulse generating circuit 100 and sustain pulse generating circuit 200 in accordance with the exemplary embodiment of the present invention. First, the details and operation of sustain pulse generating circuit 100 and sustain pulse generating circuit 200 are described. Panel 21 is electrically regarded as capacitance by sustain pulse generating circuit 100 and sustain pulse generating circuit 200. Therefore, in the circuit diagram of FIG. 14, panel 21 is shown electrically as inter-electrode capacity Cp, and a circuit for generating a scan pulse and an initializing voltage waveform is omitted. Sustain pulse generating circuit 100 has electric power recovering circuit 110 and clamping circuit 120. Sustain pulse generating circuit 200 has electric power recovering circuit 210 and clamping circuit 220.

Next, the configuration and operation of electric power recovering circuit 110 and clamping circuit 120 of sustain pulse generating circuit 100 are described in detail. Electric power recovering circuit 110 has capacitor C10 for recovering electric power, switching elements Q11 and Q12, diode D11 for preventing back flow, diode D12, and inductor L10 for resonance. Clamping circuit 120 has switching element Q13 for clamping scan electrodes Y1 through Yn on power supply VS whose voltage value is Vs, and switching element Q14 for clamping scan electrodes Y1 through Yn on ground potential. Electric power recovering circuit 110 and clamping circuit 120 are connected to scan electrodes Y1 through Yn as one end of inter-electrode capacity Cp via a scan pulse generating circuit (not shown because the circuit is in a short circuit state in the sustain period).

Electric power recovering circuit 110 LC-resonates inter-electrode capacity Cp and inductor L10 to raise and fall a sustain pulse. During the rising of the sustain pulse, electric power recovering circuit 110 moves charge accumulated in capacitor C10 for recovering electric power to inter-electrode capacity Cp via switching element Q11, diode D11, and inductor L10. During the falling of the sustain pulse, electric power recovering circuit 110 returns charge accumulated in inter-electrode capacity Cp to capacitor C10 for recovering electric power via inductor L10, diode D12, and switching element Q12. Thus, the sustain pulse is applied to scan electrodes Y1 through Yn. Electric power recovering circuit 110 drives scan electrodes Y1 through Yn by LC-resonance without electric power from the power supply, so that the power consumption is 0 ideally. Capacitor C10 for recovering electric power has a capacity sufficiently larger than inter-electrode capacity Cp, and is charged up to about Vs/2,namely a half voltage value Vs of power supply VS, so as to work as the power supply of electric power recovering circuit 110.

Clamping circuit 120 clamps scan electrodes Y1 through Yn on voltage Vs by connecting scan electrodes Y1 through Yn to power supply VS via switching element Q13. Clamping circuit 120 clamps scan electrodes Y1 through Yn on 0 (V) by grounding them via switching element Q14. Clamping circuit 120 thus drives scan electrodes Y1 through Yn. Therefore, the impedance during voltage application by clamping circuit 120 is small, and large discharge current by strong sustain discharge can be made to flow stably.

Thus, sustain pulse generating circuit 100 applies the sustain pulse to scan electrodes Y1 through Yn using electric power recovering circuit 110 and clamping circuit 120 by controlling switching element Q11, switching element Q12, switching element Q13, and switching element Q14. These switching elements can be formed of a generally known element such as a metal oxide semiconductor field effect transistor (MOSFET) or an insulated gate bipolar transistor (IGBT).

Sustain pulse generating circuit 200 has electric power recovering circuit 210 and clamping circuit 220. Electric power recovering circuit 210 has capacitor C20 for recovering electric power, switching element Q21, switching element Q22, diode D21 for preventing back flow, diode D22, and inductor L20 for resonance. Clamping circuit 220 has switching element Q23 for clamping sustain electrodes X1 through Xn on voltage Vs, and switching element Q24 for clamping sustain electrodes X1 through Xn on ground potential. Sustain pulse generating circuit 200 is connected to sustain electrodes X1 through Xn as one end of inter-electrode capacity Cp. The operation of sustain pulse generating circuit 200 is the same as that of sustain pulse generating circuit 100, and hence is not described.

FIG. 14 also shows the following elements:
power supply VE1 for generating voltage Ve1 for reducing the potential difference between electrodes of display electrode pairs 7;
power supply VE2 for generating voltage Ve2;
switching element Q26 for applying voltage Ve1 to sustain electrodes X1 through Xn;
switching element Q27;
switching element Q28 for applying voltage Ve2 to sustain electrodes X1 through Xn; and
switching element Q29.

The cycle of LC resonance between inter-electrode capacity Cp and inductor L10 of electric power recovering circuit 110, and the cycle (hereinafter, referred to as “resonance cycle”) of LC resonance between inter-electrode capacity Cp and inductor L20 of electric power recovering circuit 210 can be determined using equation 2π√(LCp). Here, L is inductance of each of inductor L10 and inductor L20.

As discussed above, sustain pulse generating circuits 100 and 200 have electric power recovering circuits 110 and 210 and clamping circuits 120 and 220, respectively, and control the rising of the sustain pulse by controlling the driving time of electric power recovering circuits 110 and 210.

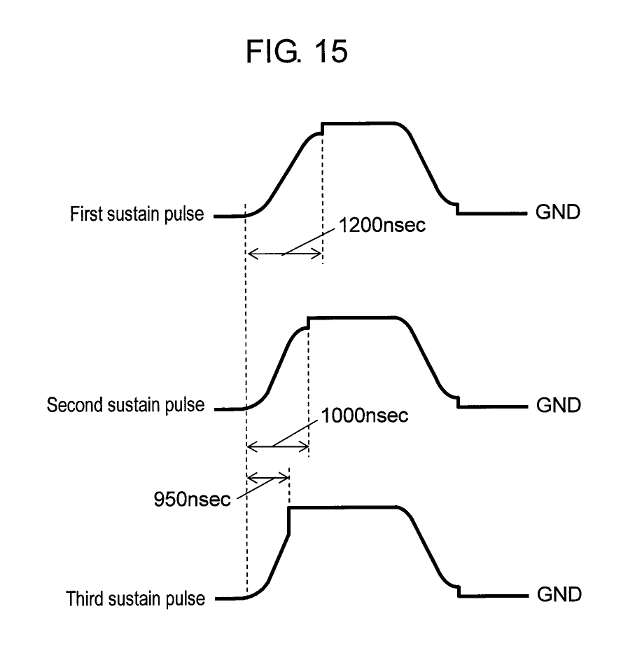

FIG. 15 is a schematic waveform chart showing first, second, and third sustain pulses in accordance with the exemplary embodiment of the present invention. In the present embodiment, the rising time of a first sustain pulse as the reference is set to about 1200 nsec, and the rising time of a second sustain pulse is set to about 1000 nsec. The rising time of a third sustain pulse is set to about 950 nsec. The rising of the second sustain pulse is set to be steeper than that of the first sustain pulse, the rising of the third sustain pulse is set to be steeper than that of the second sustain pulse.

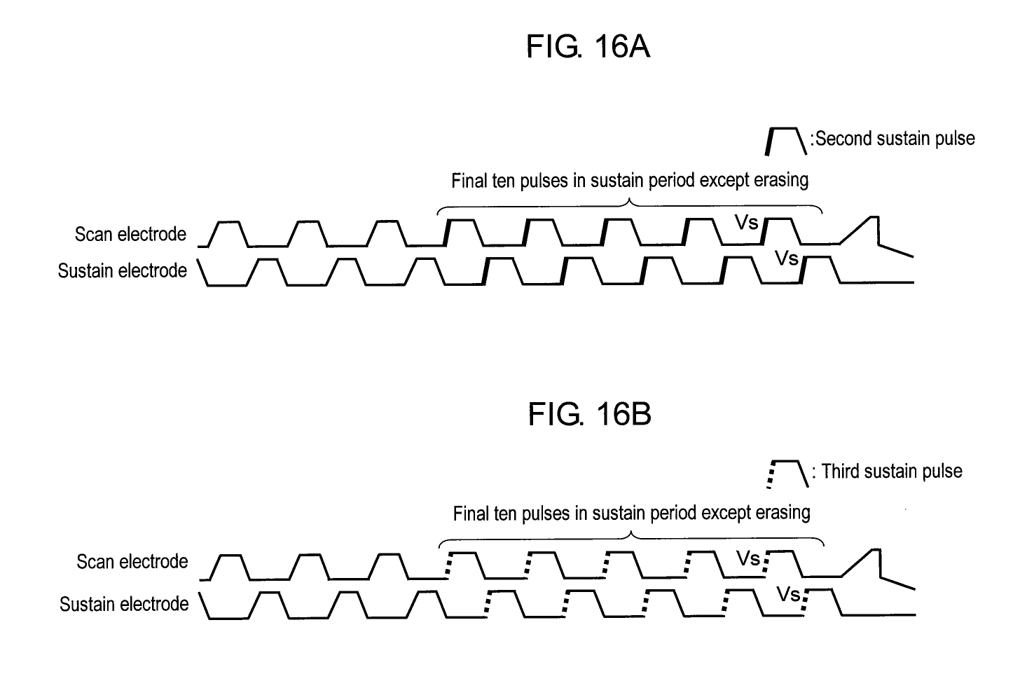

FIG. 16A and FIG. 16B are schematic diagrams showing the state where the second and third sustain pulses are continuously generated at the end of the sustain period in accordance with the exemplary embodiment of the present invention. FIG. 16A shows the state of the occurrence of the second sustain pulse in a subfield of low light-emitting rate. FIG. 16B shows the state of the occurrence of the third sustain pulse when the light-emitting rate is high.

In the present embodiment, in the sustain period, the first sustain pulse, the second sustain pulse rising more steeply than the first sustain pulse, and the third sustain pulse rising more steeply than the second sustain pulse are switched and generated, and are applied to display electrode pairs 7. As shown in FIG. 16A and FIG. 16B, at the end of the sustain period except the erasing pulse, namely in the period after several first sustain pulses at the beginning of the sustain period and before the erasing pulse, a predetermined number of second sustain pulse or third sustain pulse of a predetermined rising gradient responsive to the light emitting rate of the sustain period are generated. Here, the rising gradient of the second sustain pulse and third sustain pulse is steeper than that of the first sustain pulse, as discussed above.

Specifically, when the light emitting rate is lower than 30%, a predetermined number of second sustain pulse are continuously generated at the end of the sustain period except the erasing pulse, as shown in FIG. 16A.

When the light emitting rate is 30% or higher, a predetermined number of third sustain pulse are continuously generated at the end of the sustain period except the erasing pulse, as shown in FIG. 16B.

In FIG. 16A and FIG. 16B, the second sustain pulse and the third sustain pulse rising more steeply than the second sustain pulse are generated while being switched, and are applied to display electrode pairs 7. However, sustain pulse generating circuit 100 or sustain pulse generating circuit 200 may generate at least two kinds of sustain pulses of different rising gradients in the period after several sustain pulses at the beginning of the sustain period and before the erasing pulse, and may generate a predetermined number of sustain pulse whose rising gradient becomes steeper to the latter half in at least one-side electrodes.

In the present embodiment, such a driving method suppresses sustain current in panel 21 and uniforms the display luminance of each discharge cell 15. This is for the following reason.

As main causes of destabilizing the address discharge, the fact is recognized where wall charge formed in discharge cells 15 is insufficient or the wall charge formed in discharge cells 15 varies among discharge cells 15.

The wall charge formed in the sustain period is dependent on the intensity of sustain discharge, so that the wall charge formed in discharge cells 15 is kept insufficient when weak sustain discharge occurs. Alternatively, when the sustain discharge varies among discharge cells 15, the wall charge also varies among discharge cells 15. The address discharge in the selective initializing subfield depends on the wall charge formed in the sustain period in the immediately preceding subfield, as discussed above. In other words, sustain discharge of insufficient discharge intensity occurs, or sustain discharge varies among discharge cells 15, thereby generating unstable address discharge.

One of factors of causing sustain discharge of insufficient discharge intensity and variation of the sustain discharge among discharge cells 15 is as follows.

Lighting or non-lighting of discharge cells 15 is changed in response to a display image, so that the driving load for each display electrode pair 7 changes in response to the display image. Therefore, the rising waveform of the sustain pulse can vary, and the timing (discharge start time) of causing discharge can vary among discharge cells 15.

In panel 21 where the xenon partial pressure is increased in order to improve the luminous efficiency, the discharge start voltage between display electrode pairs 7 also increases, and the variation of the timing of causing discharge is apt to further increase.

In this case, when the timing of causing the discharge differs between adjacent discharge cells 15, discharge intensity can differ between discharge cell 15 where discharge occurs in front and discharge cell 15 where discharge occurs later. This is because discharge cell 15 to discharge in front decreases the wall charge in the discharge cell to discharge later to weaken the discharge. Alternatively, discharge of adjacent discharge cell 15 temporarily stops the discharge having started, and increase in applied voltage causes discharge again, thereby weakening the discharge.

When the sustain discharge varies among discharge cells 15 and discharge cell 15 where discharge is weaken occurs, the wall charge generated in discharge cell 15 is kept insufficient. The pulse width of address pulse voltage is reduced in enlarged panel 21 of enhanced definition, so that allowance for discharge delay or discharge variation is eliminated and address discharge is apt to become more unstable.

In order to stably cause address discharge, preferably, the discharge intensity of sustain discharge is uniformed so as to prevent variation among discharge cells 15, and the wall charge generated by sustain discharge is uniformed as much as possible. For this purpose, it is effective to cause sustain discharge in a state where variation in voltage is steep. This is because, when discharge is caused in the state where variation in voltage is steep, variation in discharge start voltage is absorbed and variation in timing of causing discharge among discharge cells 15 can be reduced. The sustain discharge caused in the state where variation in voltage is steep is strong, so that not only variation in timing of causing discharge is reduced, but also sufficient wall charge is generated in discharge cells 15.

Therefore, by generating a steeply rising sustain pulse, sustain discharge can be caused in a state where variation in voltage applied to display electrode pairs 7 is steep, and the variation in discharge start voltage can be absorbed, and the timing of causing discharge can be coincided among discharge cells 15.

While, address discharge depends on the wall charge generated at the end of the sustain period in the immediately preceding subfield, so that it is necessary to reduce variation in wall charge among discharge cells 15 and generate sufficient wall charge in discharge cells 15 at the end of the sustain period except the erasing pulse.

In other words, at the end of the sustain period except the erasing pulse, by generating sustain discharge by the second or third sustain pulses rising more steeply than the first sustain pulse as the reference, wall charge required for stable address discharge can be generated in discharge cells 15 by reducing variation in wall charge among discharge cells 15.

Since the driving load for each display electrode pair 7 varies in response to the display image, an experiment of recognizing the relationship among current flowing in a scan electrode driving integrated circuit (IC), the driving load, and the second and third pulses is performed.

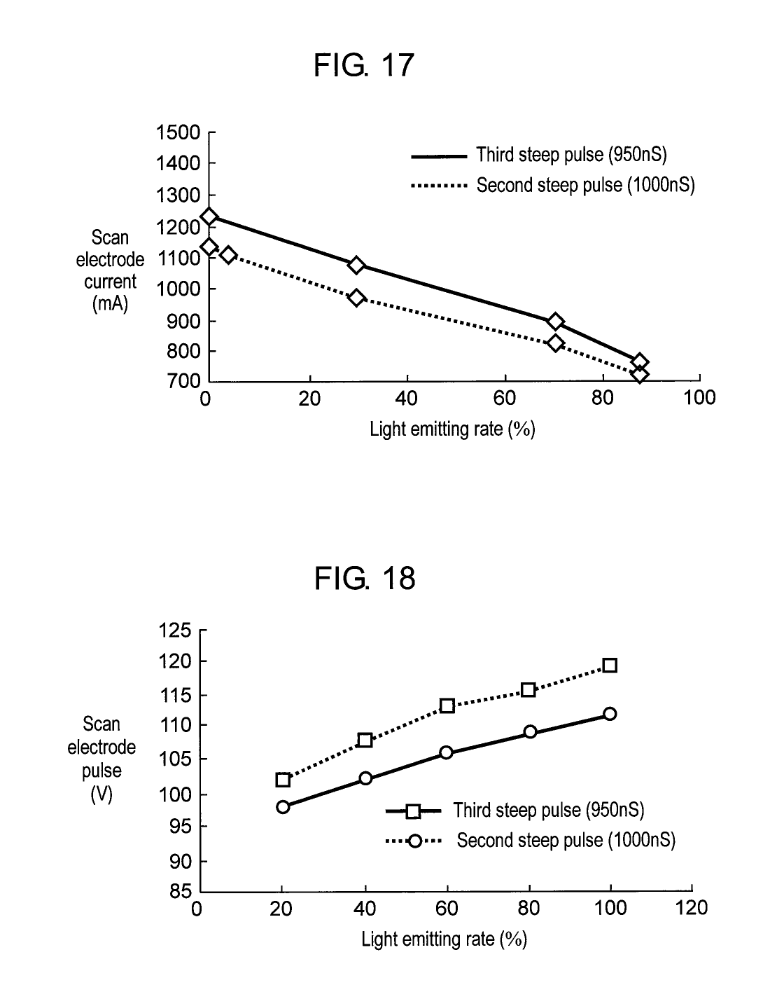

FIG. 17 is a diagram showing a relationship among current flowing in the scan electrode driving IC, driving load, and steep waveform in accordance with the exemplary embodiment of the present invention. The solid line shows the relationship between the current flowing in the scan electrode driving IC and the driving load when the third sustain pulse is used. The broken line shows the current flowing in the scan electrode driving IC and the driving load when the second sustain pulse is used.

An experiment of recognizing the varying manner of scan pulse voltage required for causing stable address discharge when the driving load varies is performed.

FIG. 18 is a diagram showing a relationship among the second sustain pulse, third sustain pulse, and scan pulse voltage that is required for causing stable address discharge in accordance with the exemplary embodiment of the present invention. The solid line shows the relationship between the driving load and the scan pulse voltage that is required for causing stable address discharge when the third sustain pulse is used. The broken line shows the relationship between the driving load and the scan pulse voltage that is required for causing stable address discharge when the second sustain pulse is used.

According to the result of the experiment, at low light emitting rate, the required scan pulse voltage is low and the current flowing in scan electrodes 5 is large. At the low light emitting rate, even when the recovering time of the second sustain pulse is set to 1000 nsec longer than the recovering time (950 nsec) of the third sustain pulse, the required scan pulse voltage can be made lower than a high light emitting rate. As a result, the current flowing in scan electrodes 5 at the low light emitting rate can be suppressed.

Thus, in the present embodiment, an initial sustain pulse (first sustain pulse in the sustain period) to be applied to scan electrodes Y1 through Yn and an initial sustain pulse (second sustain pulse in the sustain period) to be applied to sustain electrodes X1 through Xn in the sustain period are set to the first sustain pulses regardless of the order of the subfield and the light emitting rate in the sustain period. In several times at the beginning of the sustain period and at the end of the sustain period except the erasing pulse, the steeply rising second sustain pulses or third sustain pulses are continuously generated in response to the light emitting rate in the subfield at the end of the sustain period. In other words, 10 second sustain pulses are applied in response to the light emitting rate at the end of the sustain period in the following manner, for example. When the light emitting rate is lower than 30%, 10 second sustain pulses are continuously generated at the end of the sustain period except the erasing pulse. When the light emitting rate is 30% or higher, 10 third sustain pulses are continuously generated at the end of the sustain period except the erasing pulse.

In the present embodiment, thanks to such a driving method, the sustain discharge at the beginning of the sustain period is stably caused, the sustain discharge is continuously and stably caused, and variation in emission intensity of the sustain discharge is suppressed. Variation in wall charge for address generated by the sustain discharge is reduced, and subsequent address discharge is stably caused. This reduces the peak current flowing in scan electrodes 5 in panel 21, can uniform the display luminance of discharge cells 15, and can improve the image display quality.

As discussed above, the current flowing in scan electrodes 5 can be suppressed, the display luminance of each discharge cell 15 can be uniformed, and the image display quality can be improved by the following process. The first sustain pulse is generated at the beginning of the sustain period, and a predetermined number of second sustain pulse or third sustain pulse rising more steeply than the first sustain pulse as the reference are generated continuously in response to the light emitting rate in the sustain period at the end of the sustain period except the final erasing pulse.

This experiment is performed using 50-inch panel 21 having 768 display electrode pairs, and the above-mentioned numerical values are simply set based on panel 21. The present embodiment is not limited to these numerical values. Preferably, the specific numerical values of the rising periods or overlap periods of the sustain pulses are optimally set according to the specification of the plasma display device or the characteristic of panel 21.

In the present embodiment, the recovering time of the second sustain pulses or third sustain pulses in response to the light emitting rate is not limited to the above-mentioned configuration. For example, when the light emitting rate is lower than 30%, all remaining sustain pulses other than first two sustain pulses and the erasing pulse in the sustain period may be set as the second sustain pulses. When the light emitting rate is 30% or higher, the third sustain pulse may be generated at the end of the sustain period except the erasing pulse. The light emitting rate of 30% is used as the threshold in the present embodiment, but two of the light emitting rate of 30% and the light emitting rate of 50% may be switched. The present invention is not limited to this numerical value. The threshold of the light emitting rate and the number of switching are optimally set according to the characteristic of panel 21 or the specification of the plasma display device. Sustain pulse generating circuit 100 or sustain pulse generating circuit 200 may generate a sustain pulse whose rising gradient becomes steeper as the light emitting rate of the subfield increases.

The present embodiment is not limited about sustain pulses except first two sustain pulses in the sustain period, the final erasing pulse, and the continuously applied second or third sustain pulses. For example, only the first sustain pulse as the reference may be generated. The first sustain pulses and second sustain pulses may be mixed. Sustain pulses may be changed appropriately according to the order of the subfields and the luminance weight.

The other specific numerical values used in the present embodiment are simply one example, and preferably are set to the optimal values according to the characteristic of panel 21 or the specification of the plasma display device. These numerical values may vary in a range producing the above-mentioned effect.

### INDUSTRIAL APPLICABILITY

The present invention can reduce the peak current flowing in the scan electrodes in a panel and uniform the display luminance in the discharge cells, and hence is useful as a plasma display device and a driving method of the panel.

### REFERENCE MARKS IN THE DRAWINGS

1 front plate
1a, 13c rising section
2 rear plate
3 discharge space
4, 10 substrate
5 scan electrode
5b, 6b upper layer
5a, 6a lower layer
6 sustain electrode
7 display electrode pair
8 dielectric layer
9 protective film
11 insulator layer
12 data electrode
13 barrier rib
14R red phosphor layer
14G green phosphor layer
14B blue phosphor layer
15 discharge cell
17 display region
18 non-display region
19 dummy electrode pattern
20 wiring pattern
21 plasma display panel (panel)
100, 200 sustain pulse generating circuit
110, 210 electric power recovering circuit
120, 220 clamping circuit

1. A plasma display device comprising:
a plasma display panel having a plurality of discharge cells including a display electrode pair that is formed of a scan electrode and a sustain electrode; and
a sustain pulse generating circuit including:
an electric power recovering circuit for raising or falling a sustain pulse by resonating an inductor and inter-electrode capacity of the display electrode pair; and
a clamping circuit for clamping voltage of the sustain pulse on a predetermined voltage,
generating as many sustain pulses as the number corresponding to luminance weight in a sustain period in a plurality of subfields disposed in one field period, and applying each sustain pulse to each display electrode pair,
wherein the sustain pulse generating circuit generates a second sustain pulse in a period after a first sustain pulse and before an erasing pulse, the first sustain pulse occurring at the beginning of the sustain period, the second sustain pulse being steeper than the rising gradient of the first sustain pulse, and
wherein the sustain pulse generating circuit changes rising gradient of the second sustain pulse in response to light emitting rate of the plasma display panel in the sustain period.

2. The plasma display device of claim 1 wherein
the sustain pulse generating circuit generates the second sustain pulse whose rising gradient becomes steeper as light emitting rate of the subfield increases.

3. A driving method of a plasma display panel for driving the plasma display panel that has a plurality of discharge cells including a display electrode pair that is formed of a scan electrode and a sustain electrode, the driving method comprising:
providing one field period with a plurality of subfields including:
an address period for selecting a discharge cell to cause discharge; and
a sustain period for applying as many sustain pulses as the number corresponding to luminance weight to the discharge cell;
generating a second sustain pulse in a period after a first sustain pulse and before an erasing pulse, the first sustain pulse occurring at the beginning of the sustain period, the second sustain pulse being steeper than the rising gradient of the first sustain pulse; and
changing rising gradient of the second sustain pulse in response to light emitting rate of the plasma display panel in the sustain period.
